(19) United States
(12) Patent Application Publication
(10) Pub. No.: US 2013/0123975 A1
(43) Pub. Date: May 16, 2013

(54) DELIVERY UNIT FOR AN APPLICATION SYSTEM

(71) Applicant: Henkel AG & Co., KGaA, Duesseldorf (DE)

(72) Inventor: David Duckworth, Wilpshire (GB)

(73) Assignee: Henkel AG & Co. KGaA, Duesseldorf (DE)

(21) Appl. No.: 13/734,521

(22) Filed: Jan. 4, 2013

Related U.S. Application Data
(63) Continuation of application No. PCT/EP2011/061453, filed on Jul. 7, 2011.

(30) Foreign Application Priority Data
Jul. 7, 2010 (EP) 10168716.8

(51) Int. Cl. B05C 11/10

(52) U.S. Cl. CPC B05C 11/10
USPC 700/236

(57) ABSTRACT

Delivery unit for an application system for an industrial application of an adhesive and/or sealant comprising a line system for the adhesive and/or sealant and an input suitable for the connection of a storage container to the delivery unit and an output suitable for the connection of a dispensing means to dispense the adhesive and/or sealant and a feed pump and a measuring unit to collect data especially about the amount of fed adhesive and/or sealant and an interface to tap the data collected by the measuring unit.

The invention is about a delivery unit for an application system for an industrial application of an adhesive and/or sealant for example a hot melt. The invention is furthermore about an application system comprising a said delivery unit. The said delivery unit can especially be used for an upgrade of or for short-term trials with an application system replacing an older delivery unit.

The EP1792663A1 discloses a delivery unit which can be used in an application system, for the processing of low temperature hot melt adhesive comprising a melt tank for the adhesive as well as heating elements and an auto feed device integrally connected to the tank. This delivery unit is a closed system for automatically processing and application of an adhesive and can be used in an application system for the adhesive. It could also be used for an upgrade of older application systems. But the delivery unit provides no possibility to monitor the amount of dispensed adhesive or to monitor any characteristics of the adhesive.

German Utility Model No. 296 20 763.2 describes an application system which consists of an adhesive reservoir, a feed pump and an applicator head comprising at least one applicator nozzle. The adhesive reservoir, the feed pump and the applicator head are connected by a pipe carrying the adhesive. At least one sensor for the adhesive volume flow rate between the feed pump and the at least one applicator nozzle is provided. The function of this sensor for the adhesive volume flow rate is to measure the volume of adhesive actually delivered by the feed pump to at least one applicator nozzle. If in the course of a work cycle the sensor should detect that not enough adhesive, if any, is being delivered, a corresponding monitoring circuit triggers an immediate interruption in production readily discernible to the machine attendant. The application system does not comprise a closed delivery unit therefore any upgrade of the application system could be very expensive.

An object of the invention is to provide an advanced delivery unit providing the possibility to monitor the safe dispensing of an adhesive and/or a sealant.

The mentioned object is solved with the invention described with the features of claim 1. Advantageous embodiments of the invention are described with the dependent claims.

The invention overcomes the identified disadvantages and solves the mentioned object by providing a delivery unit for an application system for an industrial application of an adhesive and/or sealant comprising a line system for the adhesive and/or sealant and an input suitable for the connection of a storage container to the delivery unit and an output suitable for the connection of a dispensing means to dispense the adhesive and/or sealant and a feed pump and a measuring unit to collect data especially about the amount of fed adhesive and/or sealant and an interface to tap the data collected by the measuring unit.

It can be understood that such a delivery unit can also be used for any industrial or non industrial application of any other product like additives, auxiliary materials, food products, detergents or any other material which is suitable to be dispensed with known delivery units.

Preferably the delivery unit comprises additionally an especially closed housing or casing so that the said assembly parts are saved from for instance dust, dirt or environmental influences. The described delivery unit is preferably a closed and independent unit which can be attached to further assembly parts of an application system via for example the input and the output. Therefore the delivery unit can be used for an upgrade of existing application systems as well as for new application systems and especially provides a possibility to replace an older available delivery unit in a short time frame without great stoppage of the application system.

An essential advantage is the equipment of a measuring unit to collect data especially about the amount of fed adhesive and/or sealant. It is possible to use for example a flow meter, a pump speed sensor, a pressure gauge, a temperature sensor, a sensor for a filling level of a tank or storage container for the adhesive and/or sealant as a measuring unit built in the delivery unit or a combination of any of the said or other known measuring units.

In a lot of known application systems a multitude of dispensing means, like applicator heads with application or jetting nozzles for the application of the adhesive and/or sealant are used. It is often desirable to measure for instance the amount of material or other parameters of the material. Preferably the measuring unit is not attached directly to any of these dispensing means but is rather part of the closed delivery unit especially to save costs. It could be advantageously to have only one measuring unit for a special measuring value within the closed delivery unit instead of several measuring units at every dispensing means.

A further advantage is the equipment of an interface to tap the data collected by the measuring unit as part of the delivery unit. Tapping the data could especially mean choosing and/or retrieving data stored within the delivery unit or directly from a measuring unit. But it is also possible to provide a sending possibility for data via the interface to the delivery unit for example to control the speed of any pump or the heat of a heating element which could be used for example to melt a hot melt adhesive.

Especially for monitoring of the application or dispensing process of the sealant and/or adhesive it is advantageous to provide a possibility to tap the data. The measured data could for example be used to check the need for an adjustment of any parameter of the delivery unit to change for instance the dispensing speed, temperature, pressure and/or flow rate. It is also possible to use the tapped signal for any further process or to control any further part of the application system where the delivery unit is built in. It could therefore for instance be possible to adjust the speed of any conveyor transporting the product to be glued by any adhesive dispensed by the delivery unit with the data tapped with the interface.

As an interface to tap the data every suitable communication interface which is known to a person skilled in the art could be used. Especially hardware interfaces like parallel ports or serial ports can be used. Especially the use of a serial port EIA-232 or USB is possible. It is also possible to use a wireless interface using Bluetooth, Infrared or IEEE 802.11. In a preferred embodiment a wireless possibility is provided to tap the data by using a telemetric module as in interface or as part of the interface. It could be advantageous to use a data transmitting via GSM/UMTS. When using such a technology the used interface could for example be a GSM-module suitable to communicate with a corresponding external sending and/or receiving module. It is also possible to use any other preferably all-digital cellular network for such a wireless communication possibility wherein a module is used as an interface which suits to the said cellular network. With an interface using a cellular network it is possible to use for example internet, GPRS, CSD or HSCSD for the communication or even SMS.

A further advantage is to provide a display within the delivery unit to provide a reading or metering possibility directly at the delivery unit of for example the data and measurements measured by a measuring unit. It could be suggested to use a LCD (liquid crystal display) as a display, especially an active matrix-LCD, passive-matrix LCD or a TFT. As an alternative it could be suggested to use a plasma display. Furthermore it is possible to use an organic light emitting diode (OLED) as a display, whose emissive electroluminescent layer is composed of a film of organic compounds that emits light when an electric current passes through it. Especially the use of polymer light-emitting diodes (PLED) or small molecule organic light emitting diodes (SOLED) could be suggested.

A further advantage is to provide a control unit preferably within the delivery unit with a corresponding data processing program to handle the data collected by the measuring unit. Preferably the interface is connected to the control unit to provide a possibility to tap the data for example handled by the processing system, which could also comprise or stand for any processing and/or rendering of the data processing system. Preferably the control unit is equipped with a storage medium for the data processing system and/or for other data. As a storage medium any suitable memory device known to a person skilled in the art could be used. For example electrical memory devices could be used or semi-conductor memory devices, for example volatile memory as for example DRAM (dynamic random access memory) or SRAM (static random access memory). It is also possible to use non-volatile or permanent memory like for example ROMs (read only memory) or PROM (programmable read only memory), or semi permanent memory, like for example EPROM's (erasable programmable read only memory), EEPROM's (electrically erasable programmable read only memory), FRAMs, MRAM's or Phase Change RAM.

In an advantageous embodiment a said control unit is provided suitable for a regulation of the feed pump to control the amount of adhesive and/or sealant to be fed by the feed pump via the data read by a measuring unit. Preferably the control unit uses the signals and/or data from a measuring unit like for example a flow meter or a thermometer built into the delivery unit to adjust and control the feed pump to adjust the amount of adhesive and/or sealant to be dispensed. It is also possible to store reference values for any or every data measured by any measuring unit and to adjust the feed pump to approximate the measured data to the reference value to optimize the dispensing of the sealant and/or adhesive.

It could be furthermore advantageous to provide an interface, which comprises a telemetric module, especially a telemetric output module, to provide a reading and/or picking and/or downloading possibility of the data preferably measured by any measuring unit at a different location and/or a transference possibility of the data to and/or from a different location. Such a telemetric output module could be suitable to perform data transmitting via GSM/UMTS for example or any other suitable network or wireless transmission possibility as said above. An essential advantage of such a telemetric module is the transmission possibility of the gathered data to for example distant places like a master station for monitoring the application process or for example any external service agency handling the attendance of the application system.

It could be in addition or alternatively be suggested to provide an interface, which comprises a telemetric input module to provide a sending and/or transmitting possibility from a different location to the delivery unit and especially to a control unit of the delivery unit. With the use of a telemetric input module it is for example possible to adjust any parameter of any component part of the delivery unit or any other component part of the application system attached to the delivery unit. For example the pump speed of the feed pump could be adjusted and increased to increase the flow rate of the sealant and/or adhesive to be dispensed. Especially any suitable telemetric module as said above and any known transmission possibility as said above can be used for the said telemetric input module.

It could be furthermore advantageously to use an interface with a telemetric output module and also a telemetric input module to read data for example gathered from any measuring unit on the one hand and to adjust for example any component part like the speed of the feed pump on the other hand.

It could also be advantageous to provide input means for further data or to connect any further measuring unit or control unit, wherein the collected data are tappable via the interface. A suitable input means could be a connector for any electrical connection known to a person skilled in the art like for example RJ connectors, for instance RJ-45 or Ethernet-connectors as well as 8P8C connectors, BNC-connectors, D-subminiature connectors, USB-connectors, Radio frequency connectors or the like. With such an input means it is possible to connect for example any external measuring unit which is not part of the delivery unit to the latter. It could supposable to connect for example a quantity measuring device to the delivery unit to collect data about the products where the adhesive and/or sealant is to be dispensed or a filling level measuring device to get information about the filling level of an external tank for the adhesive and/or sealant. These and other data are readable or tappable via the connector and can be tapped or read via the interface as said above. It is also possible to use in addition a said control unit with for example a data processing program or a storage device to handle the measured data or to store the data.

Such a connector provides the possibility to connect any external measuring unit which is for example part of the application system to the delivery unit and provides especially a reading possibility of the data measured by this measuring unit via the interface. It could therefore be possible that the whole application system with suitable measuring units could be monitored with the delivery unit by tapping or reading every gathered data via the interface. With such a delivery unit also older application systems with less monitoring possibilities could be upgraded and only one possibility to read or tap every measured data is necessary by providing a said input means in combination with a said interface.

The invention overcomes furthermore the identified disadvantages and solves the mentioned object by providing an application system for an industrial application of an adhesive and/or sealant comprising a storage container for the adhesive and/or sealant, a delivery unit with a line system for the adhesive and/or sealant, which is connected to the storage container via an input, with an output suitable for the connection of a dispensing means and with a feed pump, a measuring unit to collect data about the adhesive and/or sealant and with an interface to tap the data collected by the measuring unit and a dispensing means connected to the delivery unit via the output comprising at least one applicator head with at least one jetting nozzle.

The delivery unit could be equipped with every feature as said above like an interface which comprise a telemetric module or an input means for the connection of for example external measuring units.

A further advantage is the use of a meltable hot melt as an adhesive and/or a sealant and a storage container for the cold hot melt, a vacuum fill line for the cold hot melt and whereby the delivery unit comprises a vacuum feeder and a hot melt tank to melt the hot melt. It is also possible to use any other suitable feed unit other than a vacuum feeder to feed the cold hot melt. For example any suitable pneumatic feeding means can be used known to a person skilled in the art to feed the cold hot melt. A particular preferred delivery unit comprising a hot melt tank is described in US patent application no. US20070080157A1, which is expressly incorporated herein by reference, especially with regard to the characteristics of the hot melt tank.

Alternatively it could be suggested to use a meltable hot melt and an external storage container outside the delivery unit providing a heating unit to melt the hot melt. In this case it is possible that the delivery unit only comprises a feed pump for the molten hot melt and no further hot melt tank to melt the hot melt.

It could be furthermore advantageous to provide dispensing means comprising a plurality of applicator heads whereby the applicator heads are connected to the output via a distribution manifold. A suitable distribution manifold could be an additional component part, which is attached to the output and provides a distribution possibility of for example one main line system for the adhesive and/or sealant to be dispensed to a plurality of applicator heads. Alternatively it could be advantageous to provide an output, which is shaped as the distribution manifold so that no additional component part is necessary to provide a distribution possibility for a plurality of applicator heads.

In a preferred embodiment at least one applicator head comprises a plurality of jetting nozzles to provide for example a precise application and/or an atomized spraying and/or a plane dispense of the sealant and/or adhesive.

A further advantage is the use of a control unit with a corresponding data processing program, which is built in the delivery unit to handle the data collected by any measuring unit and wherein the interface comprises a telemetric module, like for example a telemetric output module, to provide a reading possibility of the data at a different location and/or a transference possibility of the data to and/or from a different location. Such a telemetric module could be suitable to perform data transmitting via GSM/UMTS for example or any other suitable network or wireless transmission possibility as said above. An essential advantage of such a telemetric module is the transmission possibility of the gathered data to for example distant places like a master station for monitoring the application process or for example any external service agency handling the attendance of the application system.

It could be in addition or alternatively be suggested to provide an interface, which comprises a telemetric input module to provide a sending and/or transmitting possibility from a different location to the delivery unit and especially to the control unit of the delivery unit. With the use of a telemetric input module it is for example possible to adjust any parameter of any component part of the delivery unit or any other component element of the application system attached to the delivery unit. For example the pump speed of the feed pump could be adjusted and increased to increase the flow rate of the sealant and/or adhesive to be dispensed. Any suitable telemetric module as said above and any known transmission possibility as said above can be used for the said telemetric input module.

A further advantage is the equipment of the application system with a collecting means to collect data about the amount of adhesive and/or sealant dispensed by the dispensing means an wherein the collecting means are connected in a way to the delivery unit via input means that the collected data are tappable via the interface. Preferably the connecting means is an external unit like a measuring unit connected to the delivery unit via the input means. Any suitable input means can be used as for example input means like electrical connectors as said above. A suitable collecting means could for instance be a product sensor counting the products, furnished with the adhesive and/or sealant via an applicator head or any other suitable measuring unit.

Preferred embodiments of the invention are described with the figures.

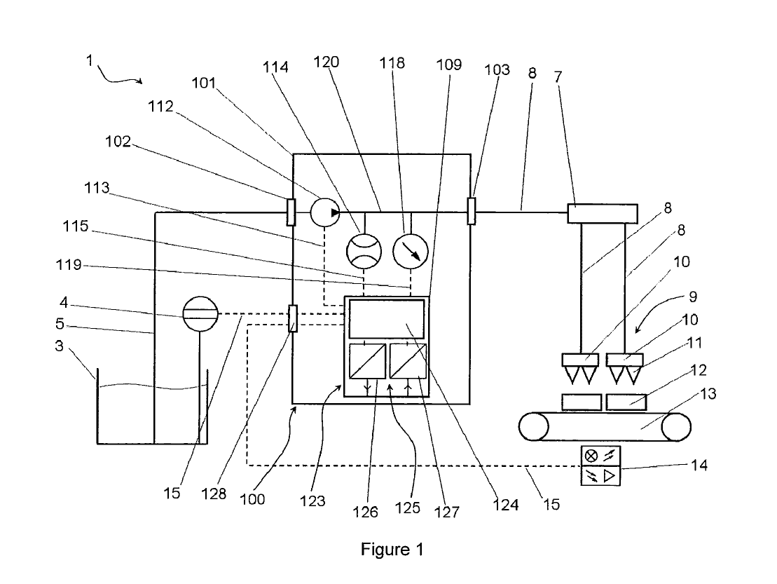

FIG. 1 shows a schematic representation of an application system with a delivery unit according to the invention.

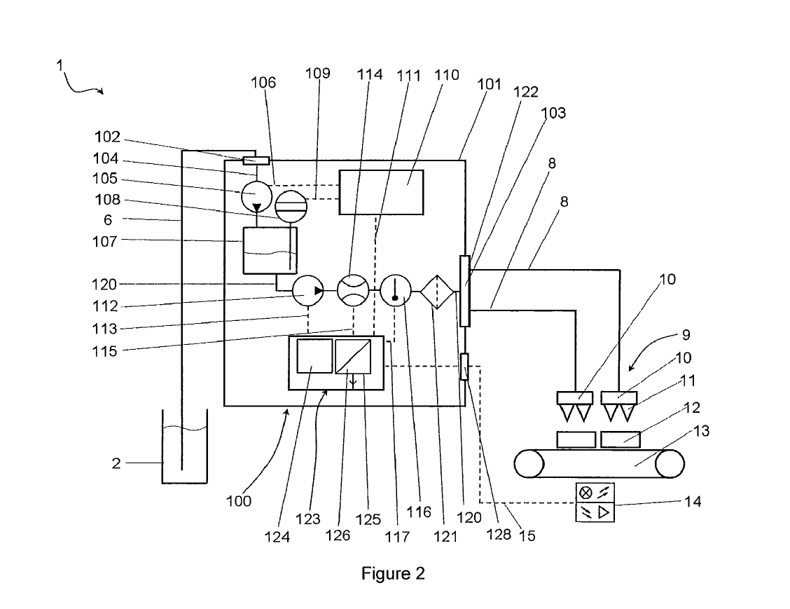

FIG. 2 shows a schematic representation of an alternative application system with a delivery unit according to the invention.

FIG. 1 shows a schematic representation of an application system 1 with a delivery unit 100 according to the invention. The application system 1 is used to dispense a hot melt adhesive to a product 12. The condition of delivery of the cold hot melt adhesive is a granulate. The cold hot melt is stored in a hot melt storage container 3 comprising a heating device for melting the hot melt and a filling level measuring device 4. The molten hot melt can be pumped via a fill line 5 trough an input 102 into a casing 101 of the delivery unit 100. The delivery unit 100 is a closed and independent unit whereby the component parts of the delivery unit 100 are protected from outer effects and influences by the casing 101. The delivery unit 100 is equipped within the casing 101 with a feed pump 112 to pump the molten hot melt through the fill line 5 into the delivery unit 100 and to an internal line system 120. It is furthermore possible to provide a heating for the fill line 5 as well as for the line system 120 to prevent a cooling and bonding of the hot melt. Furthermore the delivery unit 100 comprises several measuring units like a flow meter 114 and a pressure gauge 118 which are operatively connected to the line system 120 to measure any parameter of the hot melt within the line system 120 fed by the feed pump 112. It is also possible to provide less, additional or different measuring units within the delivery unit 100. The line system 120 with the hot melt extends to an output 103 of the delivery unit 100. The application system 1 comprises in addition a delivery hose 8 for the hot melt, which is attached to the output 103 and which could also contain a heating, which is not shown to maintain the temperature of the hot melt. The dispensing of the hot melt to the product 12 is carried out via dispensing means 9. In the shown embodiment the delivery hose 8 extends to a distribution manifold 7 to provide a distribution and a capability of connecting a plurality of applicator heads 10 each attached to the distribution manifold 7 via individual delivery hoses 8. The entity of all applicator heads 10 provides the dispensing means 9. Each applicator head 10 comprises a plurality of jetting nozzles 11 for a precise application of the hot melt to the product 12. The applicator heads 10 are fixed and the products 12 are moved through the application area of the jetting nozzles via a conveyor 13. It is also possible to provide in addition or alternatively a moving possibility for the applicator heads 10. Additionally or alternatively it is imaginable to provide a valve at the applicator heads 10 and a measuring device like a light barrier so that the hot melt is only dispensed if a product 12 is arranged in the right position relative to the applicator heads 10 to dispense the hot melt on the intended place on the product 12.

The delivery unit 100 furthermore comprises a control unit 123 within the casing 101 with a corresponding data processing program to handle the data collected by the flow meter 114 and the pressure gauge 118 as well as by the external filling level measuring device 4 and an external product sensor 14. The pressure gauge 118 is connected to the control unit 123 via a pressure gauge signal line 119. The flow meter 114 is connected to the control unit via a flow meter signal line 115. Furthermore a pump seed signal line 113 is provided for a connection between the feed pump 112 and the control unit 123. It could be suggested, especially to measure the speed of the feed pump 113 on the one hand and to adjust the pump speed on the other hand, to design any of the signal lines, especially the pump speed signal line 113 as a measuring line and also as a control line. Furthermore the external filling level measuring device 4 and the product sensor 14 are coupled each with signal lines 15 via the input means 128 with the control unit 123. The input means 118 is a multipolar female connector whereby the said signal lines 15 end in a corresponding male connector connected with the female connector to provide a connection between the delivery unit 100 and the external measuring devices. Within the delivery unit 100 the female connector is connected to the control unit 123 via a plurality of signal lines. In addition it could be supposable to provide a measuring line and/or control line between for instance the control unit 123 and in each case with the heating of the external storage container 3, the heating of the fill line 5, the delivery hose 8 and/or the line system 120, the product sensor 14 and/or any valve which is part of any application head 10.

The control unit 123 gathers all the data measured by the said internal and external measuring units and process the data with the data processing program. A display 124 as part of the delivery unit 100 is used to show any measured data or to show any information or data won from the processing of the data by the data processing program. Furthermore the data or the processed data are used to control and adjust any parameter like for example the speed of the feed pump 112 or for example the speed of the conveyor 13, the heating of the external container 3 or the line system 120 or for controlling any valve of the application heads 10.

In Addition an interface 125 is provided within or as part of the delivery unit 100 to tap the data collected by the measuring units. Tapping the data could especially mean reading, choosing and/or retrieving data stored within the control unit 123 or directly from a measuring unit or processed by the data processing program. For such a reading possibility of the said data the interface 125 comprises a telemetric output module 126 to provide a reading possibility of the data at a different location using telemetry.

In addition the shown delivery unit 100, more precisely the interface 125 comprise a telemetric input module 127 to provide a sending possibility for data via the interface 125 to the delivery unit 100 from especially a different location using telemetry. This is useful for example to control the speed of the feed pump 112 or the heat of a heating element which is part of the external hot melt storage container 3.

Such an application system with the said delivery unit 100 provides several advantages. The whole process could for instance be monitored by the delivery unit 100 containing the control unit 123 using the interface 125. Several data and parameter of the delivery unit 100 could be tapped and read out via the telemetric output module 126 to monitor the process and could also be adjusted or changed via the telemetric input module 127 to optimize the process or to interfere in case of any malfunction message or irregularity of any data. Furthermore the delivery unit 100 provides the possibility to attach or connect external measuring or control units with the control unit 123 to tap and read and/or control and adjust other component parts of the application system 1. A further advantage is the use of telemetry to tap, read, and send and to receive data because it could be done from distanced places. So it could for instance be imaginable to monitor the process not directly close to or nearby the application system 1 but rather from for example a distanced master station or from an external service agency. With the use of such a delivery unit 100 it is also possible to upgrade older application systems 1 because the inventive functionality especially for monitoring or any engagement in the process is contained within the delivery unit 100. It is also possible to use the delivery unit 100 for example for short term process control improvements and/or line efficiency improvements by substituting a known delivery unit without the said functionality in short term trials to prove for example reduced consumption of the hot melt to be dispensed.

The same advantages can be reached with the alternative application system 1 shown with a schematic representation in FIG. 2 with a delivery unit 100 according to the invention. The main difference to the application system 1 in FIG. 1 is the availability of a vacuum feeder 105 and a hot melt tank 107 which are part of the shown delivery unit 100 and contained within the housing 101. The application system 1 comprises a cold hot melt storage container 2 for a hot melt granulate. The cold hot melt is fed to the delivery unit 100 via a vacuum fill line 6 entering the delivery unit 100 trough the input 102. Inside the casing 101 of the delivery unit 100 the vacuum feeder 105 feeds the cold hot melt from the storage container 3 to the internal hot melt tank 107 comprising a heating to melt the hot melt. The vacuum feeder 105 is automatically controlled by a level sensor 108 that detects if more adhesive is needed in the hot melt tank 107. The delivery unit 100 further comprises a main power panel 110 to power the vacuum feeder 105. The main power panel 110 is connected with the vacuum feeder 105 via a vacuum pump signal line 106 and with the level sensor 108 with a level sensor signal line 109.

The hot melt tank 107 is used for melting the hot melt. It is preferably made of cast aluminum and is lined with Teflon to avoid especially carbon deposits and crystal formation, and incorporates a heating system through resistances. The heating of the resistances is controlled by a sensor with a microcontroller, which is not shown but which could be part of the main power panel 110. To melt the most known hot melts the heating can be preferably reach a temperature in the tank up to 250° C., most preferred a temperature in the range 70° C. and 190° C.

The molten hot melt is fed from the hot melt tank 107 with a feed pump 112 through a preferably heated line system 120. In the shown embodiment the feed pump 112 consists of an electro valve, a pneumatic cylinder and a double-acting hydraulic pump with a pressure compensator to avoid a drop in the flow produced in changing the direction of the pump, and enabling uniform discharge of the hot melt. The feed pump 112 has a pump speed in a range of preferably greater than 1 strokes/minute to 100 strokes/minute, most preferred in a range of 1 strokes/min to 5 strokes/min.

Several measuring units are integrated in the preferably heated line system 120 like a flow meter 114 and a thermometer 116. Furthermore a filter 121 is integrated in the line system 120 especially to filter contaminant and dirt out of the hot melt, which could plug the jetting nozzles 11 of the applicators 10. The line system 120 ends in the output 103 of the delivery unit 100 which is designed as a distribution manifold 122. The distribution manifold 122 has several outlet holes to connect the hot melt delivery hoses 8 to distribute the hot melt, once filtered by the filter 121, from the delivery unit 100 trough the said delivery hoses 8 and dispensing means 9. The latter containing the applicator heads 10 with a plurality of jetting nozzles 11 to dispense the hot melt on the product 12 moving through the dispensing area of the dispensing means 9 via a conveyor 13. The filter 121 could also be contained in the distribution manifold 122 and preferably consists of a core and fine in line filter screen to filter the for instance crystal particles or dirt that could be present in the hot melt.

The delivery unit 100 furthermore comprises the control unit 123 within the casing 101 with a corresponding data processing program to handle the data collected by the measuring units inside the delivery unit 100 via a pump speed signal line 113, a flow meter signal line 115 and a thermometer signal line 117 as well as external measuring units like the product sensor 14 which is connected to the delivery unit 100 via the input means 128 through a signal line 15. Furthermore the main power panel 110 is connected to the control unit 123 via a panel signal line 111 to provide a connection between the control unit 123 via the main power panel 110 with the feed pump 105 and the level sensor 108 and the heating of the hot melt tank 107.

The control unit 123 gathers all the data measured by the said internal and external measuring units and process the data with a data processing program. The control unit 123 further contains the display 124 or is actively connected with the display 124 contained by the delivery unit 100 to show any measured data or to show any information or data from the processing of the data by the data processing program. Furthermore the data or the processed data are used to control and adjust any parameter like for example the speed of the feed pump 112, the temperature of the heating or for example the speed of the conveyor 13, the heating of the line system 120 or for controlling any valve of the application heads 10. The preferred parameters of the delivery unit are especially a fluid temperature up to 250° C., most preferred in a range between 75° C. and 200° C. for the hot melt; a flow rate of the molten hot melt preferably in a range of greater than 0 kg/h up to 500 kg/h, most preferred in a range of 1 kg/h up to 50 kg/h; a product 12 count by the product sensor 14 in a range of from greater than 0 pieces per hour up to 20,000 pieces per hour, most preferred in a range of 1 to 2000 pieces per hour; a pump speed of the feed pump 105 preferably in a range of greater than 0 up to 100 strokes per minute, most preferred in a range of 1 to 5 strokes per minute and a liquid pressure, preferably a positive operating pressure, measured by a pressure gauge which is not shown, preferably up to 100 bar, most preferred in a range of greater than 1 bar up to 35 bar. The same parameters are preferably applicable to the application system shown in FIG. 1.

In Addition the control unit 123 is actively connected with the interface 125 to tap the data collected by the measuring units. Tapping the data could especially mean reading, choosing and/or retrieving data stored within the delivery unit 123 or directly from a measuring unit or processed by the data processing program. For such a reading possibility of the said data the interface 125 comprises the telemetric output module 126 to provide a reading possibility of the data at a different location using telemetry.

| | |
|---|---|
| 1 | application system |
| 2 | cold hot melt storage container |
| 3 | hot melt storage container |
| 4 | filling level measuring device |
| 5 | fill line |
| 6 | vacuum fill line |
| 7 | distribution manifold |
| 8 | delivery hose |
| 9 | dispensing means |
| 10 | applicator head |
| 11 | jetting nozzle |
| 12 | product |
| 13 | conveyor |
| 14 | product sensor |
| 15 | signal line |
| 100 | delivery unit |
| 101 | casing |
| 102 | input |
| 103 | output |
| 104 | vacuum fill line |
| 105 | vacuum feeder |
| 106 | vacuum feeder signal line |
| 107 | hot melt tank |
| 108 | level sensor |
| 109 | level sensor signal line |
| 110 | main power panel |
| 111 | panel signal line |
| 112 | feed pump |
| 113 | pump speed signal line |
| 114 | flow meter |
| 115 | flow meter signal line |
| 116 | thermometer |
| 117 | thermometer signal line |
| 118 | pressure gauge |
| 119 | pressure gauge signal line |
| 120 | line system |
| 121 | filter |
| 122 | distribution manifold |
| 123 | control unit |
| 124 | display |
| 125 | Interface |
| 126 | telemetric output module |
| 127 | telemetric input module |
| 128 | input means |

What is claimed is:

1. Delivery unit for an application system for industrial application of an adhesive and/or sealant comprising:
a line system for the adhesive and/or sealant;
an input for the connection of a storage container to the delivery unit;
an output for the connection of a dispensing means to dispense the adhesive and/or sealant;
a feed pump;
a measuring unit to collect data; and
an interface to tap the data collected by the measuring unit.

2. Delivery unit according to claim 1 comprising a control unit with a data processing program to process the data collected by the measuring unit.

3. Delivery unit according to claim 1 comprising a control unit for regulation of the feed pump to control the amount of adhesive and/or sealant to be fed by the feed pump in response to the data read by the measuring unit.

4. Delivery unit according to claim 1, wherein the interface comprises a telemetric module to transfer the data to and for from a different location.

5. Delivery unit according to claim 1 comprising input means for input of further data, wherein the further data is tappable via the interface.

6. The delivery unit of claim 1 where the measuring unit collects data about the amount of dispensed adhesive and/or sealant.

7. Application system for industrial application of an adhesive and/or sealant comprising:
a storage container for an adhesive and/or sealant,
a delivery unit with a line system for the adhesive and/or sealant, which is connected to the storage container via an input, with an output for the connection of a dispenser and with a feed pump, a measuring unit to collect data about the adhesive and/or sealant and with an interface to tap the data collected by the measuring unit; and
the dispenser connected to the delivery unit via the output and comprising at least one applicator head with at least one jetting nozzle.

8. Application system according to claim 7, wherein the adhesive and/or sealant is a meltable hot melt composition with a storage container for cold hot melt composition, a vacuum fill line and whereby the delivery unit comprises a vacuum feeder and a hot melt tank to melt the hot melt composition.

9. Application system according to claim 7, wherein the dispenser comprises a plurality of applicator heads wherein the applicator heads are connected to the output via a distribution manifold.

10. Application system according to claim 9, wherein the output comprises a distribution manifold.

11. Application system according to claim 7, wherein the at least one applicator head comprises a plurality of jetting nozzles.

12. Application system according to claim 7 comprising a control unit with a data processing program incorporated into the delivery unit, the control unit receiving the data collected by the measuring device, and wherein the interface comprises a telemetric module to transfer the data to and/or from a different location.

13. Application system according to claim 7 comprising a collecting means to collect data about the amount of adhesive and/or sealant dispensed by the dispenser, wherein the collecting means is connected to the delivery unit via the input and data in the collecting means is tappable via the interface.
